(19) United States
(12) Patent Application Publication
(10) Pub. No.: US 2016/0230804 A1
(43) Pub. Date: Aug. 11, 2016

(54) Snap Hook

(71) Applicant: Chin-Shun Huang, Changhua County (TW)

(72) Inventor: Chin-Shun Huang, Changhua County (TW)

(21) Appl. No.: 14/617,286

(22) Filed: Feb. 9, 2015

(51) Int. Cl. F16B 45/02

(52) U.S. Cl. CPC F16B 45/02

(57) ABSTRACT

A snap hook includes a body, a gate, a lock and a security device. The body includes an opening and a cutout. The gate is pivotally connected to the body between a closing position to close the opening and an opening position to open the opening. The lock is pivotally connected to the body between a locking position to avoid pivoting of the gate into the opening position and a releasing position to allow the gate to pivot into the opening position. The security device includes a switch movably located on the lock between two positions and a tongue extending from the switch. In the first position of the switch, the tongue abuts the body to avoid pivoting of the lock into the releasing position. In the second position of the switch, the tongue is allowed to enter the cutout to allow the lock to pivot into the releasing position.

### BACKGROUND OF INVENTION

1. Field of Invention

The present invention relates to a snap hook and, more particularly, to a reliable snap hook.

2. Related Prior Art

As disclosed in U.S. Pat. No. 5,896,630, a snap hook 1 includes a body, a gate keeper 8 for closing an opening 7 made by the body, a first locking means for locking the gate keeper 8, and a second locking means 17 for locking the first locking means. The body includes a shank 2 and an arched portion 3 formed at an end of the shank 2. The gate keeper 8 is formed with two locking tabs 15. The first locking means includes a locking lever 11 pivotally connected to the shank 2. The locking lever 11 includes two locking arms 14 and a slot 21. The second locking means 17 includes a slide plate 18 and a pin 20. The pin 20 is inserted in the slot 21. The slide plate 18 includes two tabs 23 on a side. An internal spring 13 is place against another side of the slide plate 18 to force the tabs 23 towards the locking lever 11.

The pin 20 is operable to cause an end of the slide plate 18 to extend beyond the locking lever 11. The end of the slide plate 18 is kept in position as the tabs 23 are located against a closed end of the slot 21 and an end of the locking lever 11. The slide plate 18 prevents the locking lever 11 from pivoting relative to the body. The locking arms 14 abut against the locking tabs 15. Thus, the gate keeper 8 cannot be pivoted.

The pin 20 can be operated to move the end of the slide plate 18 under the locking lever 11 to allow the locking lever 11 to pivot relative to the body. However, the pin 20 must be pressed down relative to the locking lever 11 to disengage the tabs 23 from the end of the locking lever 11 and the closed end of the slot 21. Then, the pin 20 can be moved along the locking lever 11 to move the end of the slide plate 18 under the locking lever 11 to allow the locking lever 11 to pivot. The locking arms 14 are disengaged from the locking tabs 15. Thus, the gate keeper 8 can be pivoted.

As disclosed in U.S. Pat. No. 8,752,254, a snap hook 100 includes a locking member 200 located in a gate 400. However, it is difficult to insert the locking member 200 in the gate 400 since the gate 400 is small. It is also difficult to maneuver the locking member 200 because the gate 400 is small.

The present invention is therefore intended to obviate or at least alleviate the problems encountered in prior art.

### SUMMARY OF INVENTION

It is the primary objective of the present invention to provide a reliable and convenient snap hook.

To achieve the foregoing objectives, the snap hook includes an arched body, a gate, a lock and a security device. The arched body includes an opening and a cutout. The gate is pivotally connected to the arched body between a closing position to close the opening and an opening position to open the opening. The lock is pivotally connected to the arched body between a locking position to avoid pivoting of the gate into the opening position from the closing position and a releasing position to allow the gate to pivot into the opening position from the closing position. The security device includes a switch movably mounted on the lock between a first position and a second position and a tongue extending from the switch. The tongue abuts the arched body to avoid pivoting of the lock into the releasing position from the locking position when the switch is in the first position. The tongue is allowed to enter the cutout to allow the lock to pivot into the releasing position from the locking position when the switch is in the second position.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a snap hook according to the preferred embodiment of the present invention;

FIG. 2 is an exploded view of the snap hook shown in FIG. 1;

FIG. 3 is an enlarged perspective view of an arched body of the snap hook shown in FIG. 1;

FIG. 4 is an enlarged perspective view of a locking element of the snap hook shown in FIG. 1;

FIG. 5 is an enlarged perspective view of security element connected to the arched body of the snap hook shown in FIG. 4;

FIG. 6 is a cross-sectional view of the snap hook shown in FIG. 1;

FIG. 7 is a cross-sectional view of the snap hook in another position than shown in FIG. 6; and

FIG. 8 is a cross-sectional view of the snap hook in another position than shown in FIG. 7.

### DETAILED DESCRIPTION OF PREFERRED EMBODIMENT

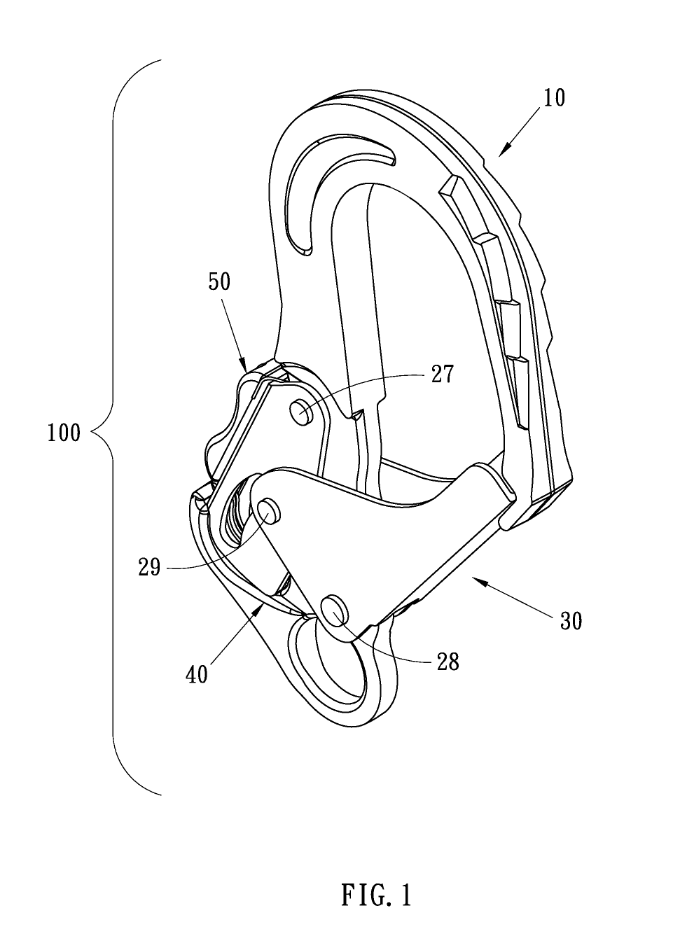

Referring to FIG. 1, a snap hook 100 includes an arched body 10, a gate 30, a lock 40 and a security device 50 according to the preferred embodiment of the present invention. The gate 30 is used to close the arched body 10. The lock 40 is used to lock the gate 30. The security device 50 is used to restrain the lock 40.

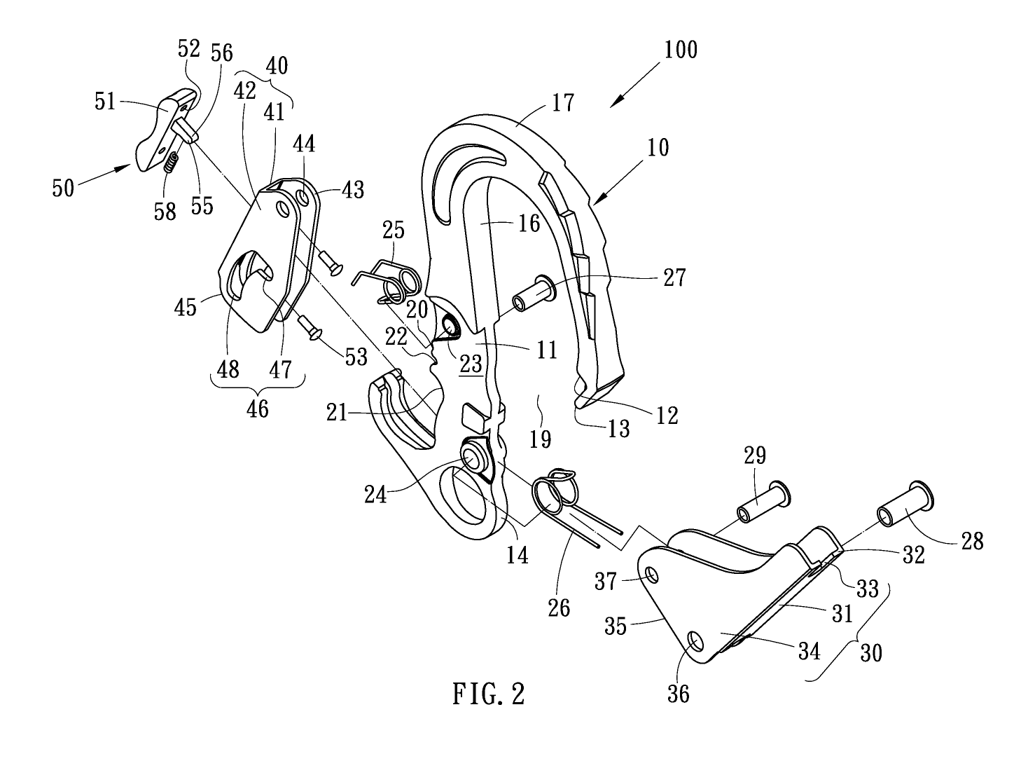

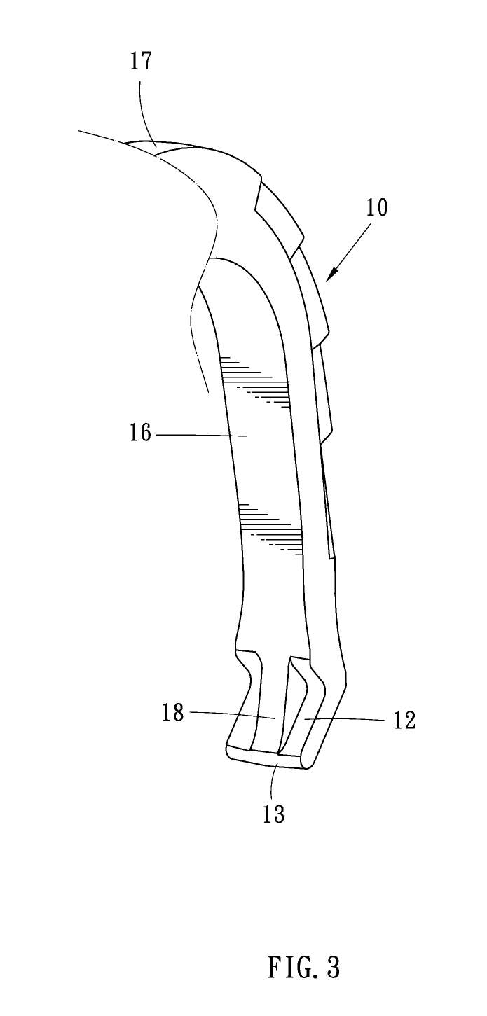

Referring to FIGS. 2 and 3, the arched body 10 includes a first end 13, a second end (not numbered), a middle section 11 between the first end 13 and the second end, and an opening 19 between the first end 13 and the middle section 11. The arched body 10 further includes an aperture 14 near the second end. The arched body 10 further includes an internal edge 16 directed to the opening 19 and an external edge 17 opposite to the internal edge 16. The arched body 10 further includes, in the vicinity of the first end 13, two recesses 12 in the internal edge 16 and a fin 18 at the internal edge 16. The recesses 12 are separated from each other by the fin 18.

The arched body 10 further includes three recesses 20, 22 and 21 in the external edge 17. The recess 22 is deeper than the recess 20. The recess 21 is deeper than the recess 22. The arched body 10 further includes two apertures 23 and 24.

Referring to FIG. 2, the gate 30 includes a front strip 31 extending between two lateral strips 34 extending parallel to each other. Each lateral strip 34 is in the form of a long triangle. Each lateral strip 34 includes a corner (the “first corner”) far from two other corners (the “second corner” and the “third corner”) between which an edge 35 extends. Each lateral strip 34 further includes an aperture 36 near the second corner and another aperture 37 near the third corner. The front strip 31 includes a first end 32 between the first corners of the lateral strips 34 and a second end (not numbered) between the second corners of the lateral strips 34. A cutout 33 is made in the first end of the front strip 31.

A fastener 28 is inserted in the apertures 36 of the lateral strips 34 and the aperture 24 of the arched body 10. Thus, the gate 30 is pivotally connected to the arched body 10. The fastener 28 is a threaded bolt, a pin, a rivet or any other proper element. The first end of the front strip 31 is located in the vicinity of the first end 13 of the arched body 10. A torque spring 26 is supported on the fastener 28. The torque spring 26 biases the first end of the front strip 31 towards the first end 13 of the arched body 10

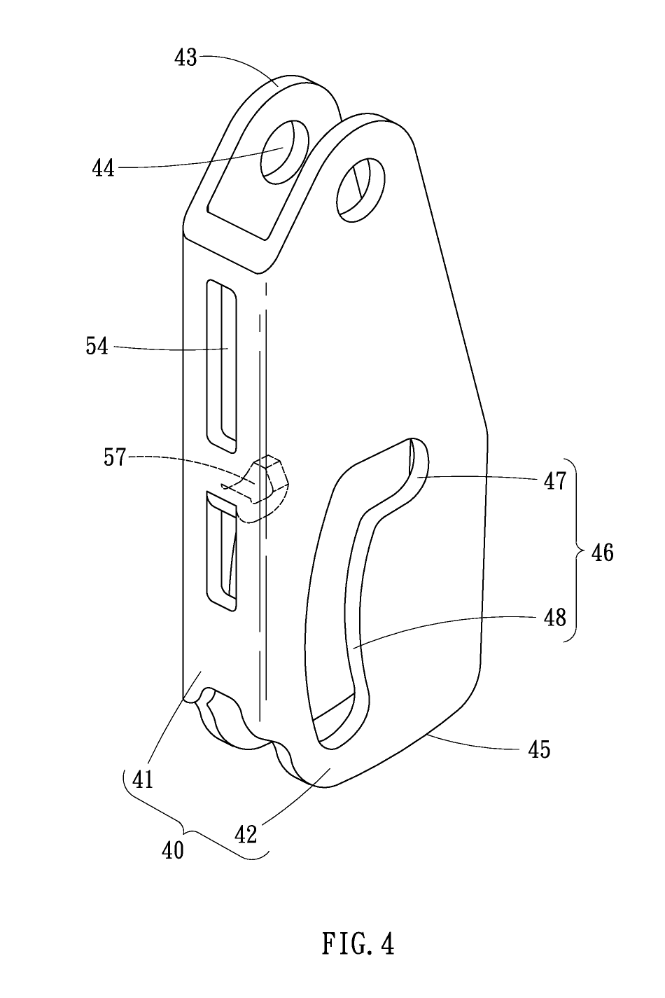

Referring to FIGS. 2 and 4, the lock 40 includes a back strip 41 extending between lateral strips 42 extending parallel to each other. The back strip 41 includes two slots 54 and a tab 57 between the slots 54. The tab 57 is preferably made of a portion of the back strip 41 that is punched out of one of the slots 54. The tab 57 preferably includes a section extending perpendicular to the back strip 41 and another section extending parallel to the back strip 41.

Each lateral strip 42 includes a first end 43, a second end 45 opposite to the first end 43, an aperture 44 near the first end 43, and a slot 46 near the second end 45. The slot 46 includes a transverse section 47 and a longitudinal section 48. The terms, “transverse” and “longitudinal”, are given with reference to the lock 40. The longitudinal section 48 of the slot 46 extends in an arched manner. The first ends 43 of the lateral strips 42 extend beyond a first end of the back strip 41 and the second ends 45 of the lateral strips 42 extend beyond a second end of the back strip 41.

A fastener 27 is inserted in the apertures 44 of the lock 40 and the aperture 23 of the arched body 10. Thus, the lock 40 is pivotally connected to the arched body 10. The fastener 27 is a threaded bolt, a pin, a rivet or any other proper element. Another torque spring 25 is supported on the fastener 27. The torque spring 25 tends to pivot the lock 40 away from the arched body 10.

A pin 29 is inserted in the slots 46 of the lock 40 and the apertures 37 of the gate 30. Thus, the lock 40 is pivotally connected to the gate 30. The pin 29 is a threaded bolt, a pin, a rivet or any other proper element. Thus, the pin 29 is moved along the slots 46 when the lock 40 is pivoted relative to the gate 30.

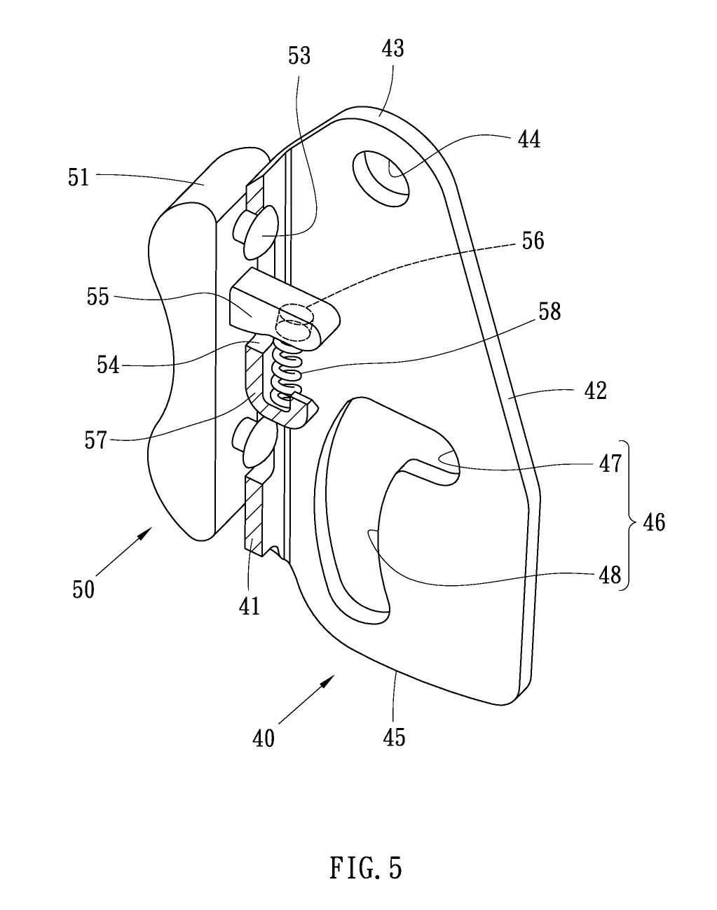

Referring to FIGS. 2, 4 and 5, the security device 50 includes a switch 51, a tongue 55, and a spring 58. Tongue 55 extends from the switch 51 transversely. The switch 51 is located on a side of the back strip 41. Two fasteners 53 are used to movably locate the switch 51 on the lock 40 between a first position and a second position. Each of the fasteners 53 includes a body and an enlarged head. The heads of the fasteners 53 are placed on an opposite side of the back strip 41. The bodies of the fasteners 53 are movable along the slots 54. The bodies of the fasteners 53 are inserted in two apertures 52 made in the switch 51. The tongue 55 is also inserted in one of the slots 54. A compression spring 58 is compressed between the tongue 55 and the tab 57. The compression spring 58 biases the tongue 55 away from the tab 57. The tongue 56 preferably includes a bore for receiving an end of the compression spring 58.

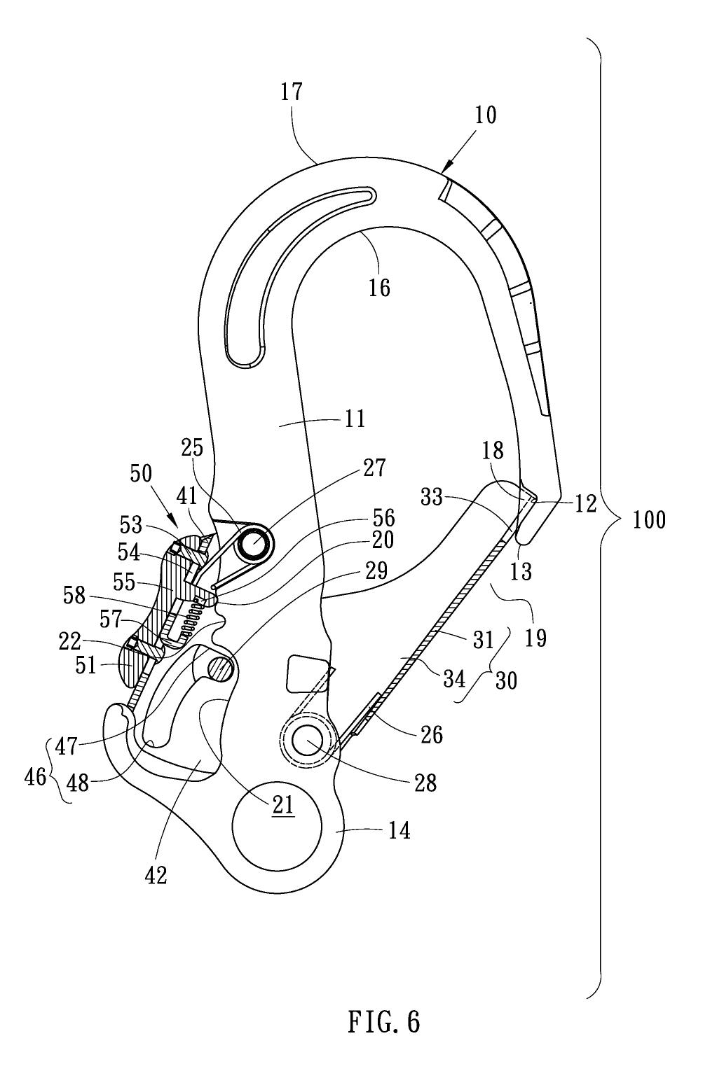

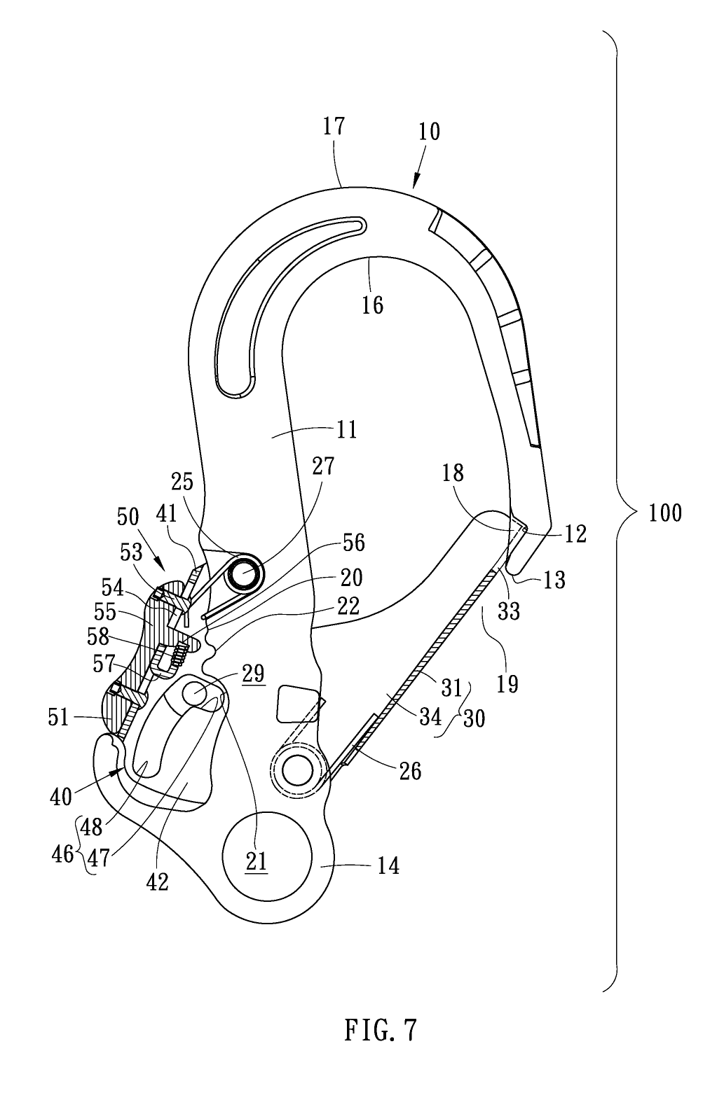

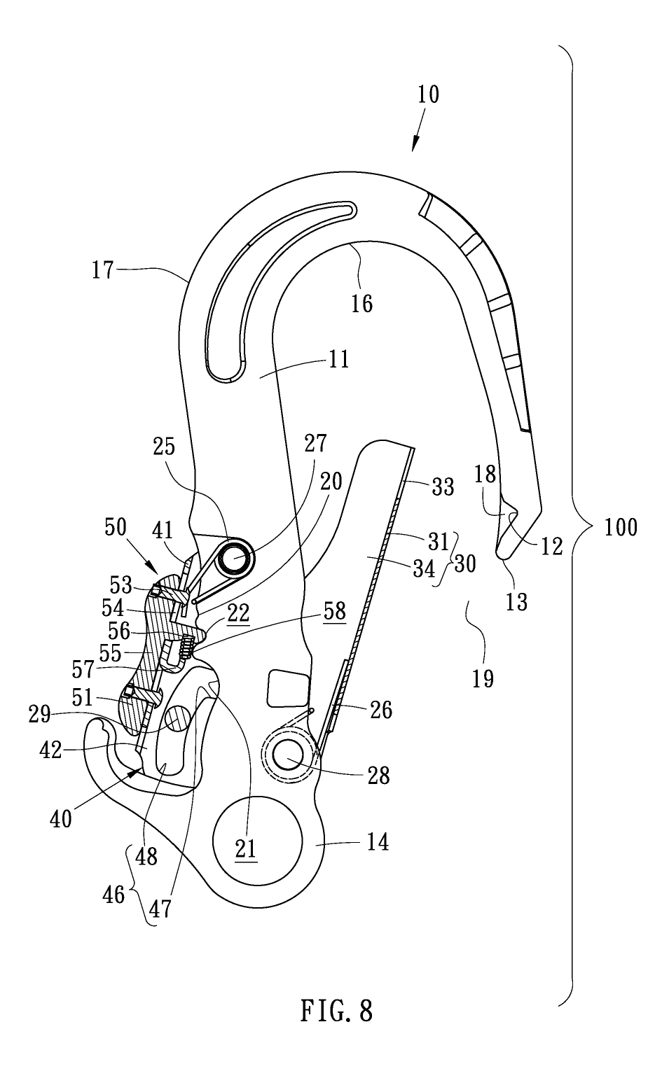

In operation, a section of a rope (not shown) is inserted through the aperture 14 near the second end of the arched body 10. The gate 30 can be pivoted between a closing position as shown in FIG. 6 and an opening position as shown in FIG. 8. The lock 40 can be pivoted between a locking position as shown in FIG. 6 and a releasing position as shown in FIGS. 7 and 8. The switch 51 can be moved between a first position as shown in FIG. 6 and a second position as shown in FIGS. 7 and 8.

Referring to FIG. 6, the gate 30 is located in the locking position. The lock 40 is located in the locking position. The switch 51 is located in the first position. The recess 20 of the arched body 10 receives the tip of the tongue 55. The switch 51 keeps the lock 40 in the locking position. An edge of the transverse section 47 of the slot 46 of each lateral strip 42 abuts against the pin 29. Thus, the lock 40 keeps in the gate 30 in the closing position. That is, the locks 40 keeps the first end 32 of the front strip 31 of the gate 30 against the first end 13 of the arched body 10. The fin 18 is inserted in the cutout 33 to keep the gate 30 in position laterally relative to the first end 13 of the arched body 10.

Referring to FIG. 7, the switch 51 is located in the second position. The tongue 55 is allowed to enter the recess 22 to allow the lock 40 to pivot into the releasing position from the locking position.

Referring to FIG. 8, the switch 51 is located in the second position. The tongue 55 is inserted in the recess 22. The lock 40 is pivoted into the releasing position from the locking position. The gate 30 is pivoted into the opening position from the closing position.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A snap hook including:
an arched body including an opening and a recess;
a gate pivotally connected to the arched body between a closing position to close the opening and an opening position to open the opening;
a lock pivotally connected to the arched body between a locking position to avoid pivoting of the gate into the opening position from the closing position and a releasing position to allow the gate to pivot into the opening position from the closing position; and
a security device including:
a switch movably mounted on the lock between a first position and a second position; and
a tongue extending from the switch, wherein the tongue abuts the arched body to avoid pivoting of the lock into the releasing position from the locking position when the switch is in the first position, wherein the tongue is allowed to enter the recess to allow the lock to pivot into the releasing position from the locking position when the switch is in the second position.

2. The snap hook according to claim 1, wherein the tongue extends from the switch transversely.

3. The snap hook according to claim 2, wherein the lock includes a slot for movably receiving the tongue.

4. The snap hook according to claim 3, wherein the lock is formed with tab, wherein the security device further includes a spring compressed between the tab and the tongue.

5. The snap hook according to claim 4, wherein the tongue includes a bore for receiving an end of the compression spring.

6. The snap hook according to claim 3, wherein the security device further includes a fastener inserted in the switch through the slot.

7. The snap hook according to claim 6, wherein the fastener includes:
a body connected to the switch; and
a head movably placed on a side of the back strip when the switch is movably placed on an opposite side of the back strip.

8. The snap hook according to claim 1, wherein the gate includes a first end for abutment against the first end of the arched body and a second end pivotally connected to the arched body.

9. The snap hook according to claim 1, further including a pin connected to the gate, wherein the lock includes a slot for receiving the pin movably.
